(19) United States
(12) Patent Application Publication
(10) Pub. No.: US 2015/0324516 A1
(43) Pub. Date: Nov. 12, 2015

(54) SYSTEMATIC CONFIGURATION AND MODE DESIGN FOR POWER SPLIT HYBRID VEHICLES USING MULTIPLE PLANETARY GEARS

(71) Applicant: THE REGENTS OF THE UNIVERSITY OF MICHIGAN, Ann Arbor, MI (US)

(72) Inventors: Huei PENG, Ann Arbor, MI (US); Jing SUN, Superior Township, MI (US); Xiaowu ZHANG, Ann Arbor, MI (US)

(21) Appl. No.: 14/706,249

(22) Filed: May 7, 2015

Related U.S. Application Data
(60) Provisional application No. 61/990,364, filed on May 8, 2014.

(51) Int. Cl. G06F 17/50; G06F 17/16; F16H 57/08

(52) U.S. Cl. CPC G06F 17/5095; F16H 57/08; G06F 17/16; F16H 2057/0087

(57) ABSTRACT

An automatic modeling and screening method capable of exhaustively searching through all configurations with all possible clutch locations and operating modes for a hybrid vehicle. By combining this method with Power-weighted Efficiency Analysis for Rapid Sizing (PEARS), a near-optimal and computationally efficient energy management strategy, it is feasible to search through an extremely large design space of configuration, component sizing and control to identify optimal designs for hybrid power vehicles.

### CROSS-REFERENCE TO RELATED APPLICATIONS

This application claims the benefit of U.S. Provisional Application No. 61/990,364, filed on May 8, 2014. The entire disclosure of the above application is incorporated herein by reference.

### GOVERNMENT INTEREST

This invention was made with government support under DE-PI0000012 awarded by the Department of Energy. The Government has certain rights in the invention.

### FIELD

The present disclosure relates to the systematic configuration and mode design for power split hybrid vehicles using multiple planetary gears.

### BACKGROUND AND SUMMARY

This section provides background information related to the present disclosure which is not necessarily prior art. This section provides a general summary of the disclosure, and is not a comprehensive disclosure of its full scope or all of its features.

Planetary Gear (PG) power-split hybrid powertrains have been used in the production vehicles such as from Toyota, Ford and General Motors. Some of them use clutches to achieve multiple operating modes to improve powertrain flexibility and efficiency. In the present disclosure, an automatic modeling and screening process is developed, which makes it possible to exhaustively search through all configurations with all possible clutch locations and operating modes. By combining this process with Power-weighted Efficiency Analysis for Rapid Sizing (PEARS), a near-optimal and computationally efficient energy management strategy, it becomes feasible to search through the extremely large design space of configuration, component sizing and control to identify optimal designs that has not been reported in the literature. A case study was conducted to compare the global optimal design identified by the developed methodology for the configuration adopted in the recent models of Prius and Hybrid Camry. Two special designs are further investigated: one uses all possible operating modes, and another sub-optimal design which limits the number of clutches to 1.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates a planetary gear (PG) system and FIG. 1B illustrates its lever analogy.

FIG. 2 illustrates all 16 possible clutch locations for a double PG system.

FIG. 3 is a diagram of THS-II.

FIG. 4 is a diagram illustrating an example of a parallel mode in THS-II configuration.

FIG. 5 is a flow chart of the PEARS process.

FIG. 6 is flow chart illustrating the power flow in the hybrid mode.

FIG. 7 is a flow chart of the Step 3 in the PEARS process.

FIGS. 8A and 8B illustrate two typical categories of configurations for a double PG system.

FIG. 9 illustrates all feasible and non-redundant modes for Configuration #83 (used in Prius 2010).

FIG. 10 illustrates the optimal mode selection for discretized FUDS cycle.

FIG. 11 illustrates the optimal mode distribution for HEV driving in the FUDS cycle.

FIG. 12 illustrates the modes most frequently used.

FIG. 13 illustrates fuel economy improvement for HEV and PHEV in combined FUDS and HWFET cycles under drivability constraint.

FIGS. 14A and 14B illustrate the top two best PHEV designs with three clutches.

FIG. 15 illustrates the engine operations points of the designs of FIG. 14A in HWFET cycle.

FIG. 16 illustrates three operating modes for Honda Accord Hybrid 2014.

FIG. 17 illustrates the frequency of mode selection for PHEV design in FUDS cycle for FIG. 14B.

FIGS. 18A and 18B are simplified designs of FIGS. 14A and 14B.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### Introduction

Hybrid electric powertrain is one of the most important technologies to achieve the challenging fuel economy standards set by the EU and US governments. According to a report from Electric Drive Transportation Association (EDTA), hybrid and electric car sales in 2012 increased by 73%. 473,000 hybrids and plug-in hybrids were sold, which captured 3.3% of the US market, a significant increase from the 2.2% share in 2011.

With electric motor(s), the engine could be right sized for improved overall efficiency. Meanwhile, regenerative braking significantly helps fuel economy in urban driving. Based on the power flow, hybrid vehicles can be classified into three categories: series, parallel and power-split.

For series hybrid, all the engine power is converted to electrical power, and later back to mechanical form. Excess engine power is stored in the battery for later use. The multiple stages of energy conversion make series hybrids inherently inefficient, which is the major reason for the fact that no production pure series hybrid passenger vehicles are available on the market from major OEMs. However, series mode can be used as a back-up mode to achieve drivability requirements. Parallel hybrids can be incremental add-on from traditional powertrain and thus incur relatively small investment and engineering effort. Among all the strong hybrid vehicles sales in 2012, over 90% of them are power-split type, which utilizes one or more planetary gears as the transmission device. The planetary gears are compact, efficient and with high capacity. In addition, they perform as an Electric Continuous Variable Transmission (ECVT) when the electric machines are properly controlled. When the powertrain devices are sized and controlled well, the hybrid vehicle can achieve good drivability and excellent fuel economy simultaneously.

When clutches are used in a power split powertrain, different operating modes can be assumed, which adds flexibility to vehicle operation. For example, input-split mode can be used for better launching performance while compound-split mode can be used for better high-speed driving while curtailing the operating speed of the electric machines. It is also possible to have parallel modes, series modes, pure EV modes and fixed-gear modes on the same powertrain. Having a diverse set of operating modes makes it possible to fully realize the potential of the powertrain.

Although many configurations and designs have been patented and some implemented commercially, much more remain unexplored. “Configuration” in the present disclosure refers to the way that the power devices (engine and generator/motors) and output shaft are connected to the nodes of Planetary Gears (PGs). Exhaustive analysis on all possible configurations has been conducted for power-split vehicles using a single planetary gear (PG). For power-split vehicles using more than one PG, a general modeling method has been developed. However, general clutch allocation, mode screening and identification of unique modes have not been discussed in the literature. In the present disclosure, an automated modeling methodology will be proposed, which will lead to models including all possible clutch locations to generate all possible modes. A systematic mode identification is carried out, with only feasible and unique modes kept for design and control study.

Once a particular configuration is selected and all its feasible modes identified, we can perform the optimal sizing and control study, which will answer the following question: “what is the best fuel economy possible for this configuration”. For example, in the present disclosure we will study the THS-II configuration, which connects the engine, two motors and the vehicle to the two planetary gears in a particular way. In addition, two “permanent clutches” are used in the THS-II design. Because the two “clutches” never change state, there is a single operating mode. Our methodology will answer other four interesting questions: how many clutches can be added and how many distinct modes can be created? Among all possible modes enabled by these clutches, how many of them are useful? If we limit ourselves to add no more than 3 clutches, where should they be located? And for the “enhanced THS-II” (by having either all possible modes, or the modes only through three clutches), how much better is the fuel economy compared with the original THS-II?

If fuel economy is the main design objective, in general, the near-optimal control problem can be solved using load leveling, Equivalent Consumption Minimization Strategy (ECMS), the Pontryagin's Minimum Principle (PMP), dynamic programming (DP) and convex optimization. The load leveling methods are heuristic with little optimality guaranteed, ECMS is an instantaneous optimization method and the equivalent fuel consumption factor needs tuning, DP is very computationally expensive, PMP frequently have numerical convergence issues associated with the underlying nonlinear two-point-boundary-value problem and the convex optimization is fast but it is only applied on series hybrid vehicle and has limited application to complex vehicle powertrain structure like power-split hybrid vehicles.

To overcome these drawbacks, a new near-optimal energy management strategy named Power-weighted Efficiency Analysis for Rapid Sizing (PEARS) was developed, and it is proved to produce optimal results similar to DP but over four orders of magnitude faster. In the present disclosure, the PEARS method is further enhanced to accommodate more general scenarios. This method will be used to generate near-optimal control results which make it possible to identify best clutch locations and optimal operating mode.

### Dynamics of Planetary Gear and Automatic Modeling

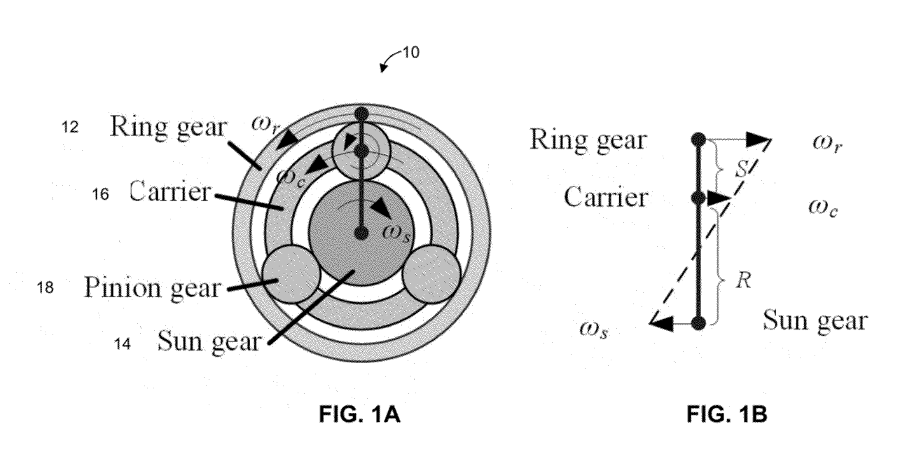

As illustrated in FIG. 1A, a planetary gear (PG) system 10 consists of a ring gear 12, a sun gear 14, and a carrier 16 with several pinion gears 18. A lever analogy can be applied to reflect the 2 degree of freedom (DoF) dynamics of this single planetary gear, as shown in FIG. 1B. The rotational speeds and accelerations of the three nodes (sun gear, ring gear, carrier) must satisfy the constraint shown in Eq. (1), where the subscripts s, r, c indicate the sun gear, ring gear and the carrier, respectively. S and R are the radii of the sun gear and ring gear, respectively.

ωₛS+ωᵣR=ω_{c}(R+S) (1)

The dynamics of PG system 10 can be represented using state-space form as suggested in the literature. In the present disclosure, a more general form of the modeling will be presented, with all possible clutch locations and modes considered.

### Multiple Planetary Gear System

Many of today's popular power-split hybrid vehicles use 2 Motor/Generators (MGs) to complement the engine. In this research, we adopt this general powertrain setup. Assuming no component colocation on any of the planetary gear node, the number of different configurations (n_{configuration}_{_{—}}ₜₒₜₐₗ) and the maximum number of clutches (n_{clutch}_{_{—}}ₜₒₜₐₗ) can be calculated by Eq. (2) and Eq. (3), where n is the number of PG sets. The first term in Eq. (3) stands for the number of clutches that can be added between each two nodes in the PGs system, while the second term represents the grounding nodes that can be implemented for each clutch. The third term is the number of redundant clutches that can be eliminated from the system: for each PG, locking any two nodes makes all three nodes rotate at the same speed, which renders that only one such clutch is needed. Therefore, for each PG, (C₃²−1=2) clutches can be eliminated. In addition, the grounding clutch for the vehicle output shaft is meaningless during driving, leading to a −1 term in (3). Since no component colocation is allowed, the total number of nodes should be greater or equal to 4 (n>1).

n_{Configuration}_{_{—}}ₜₒₜₐₗ=C₃ₙ⁴(2)

n_{clutch}_{_{—}}ₜₒₜₐₗ=C₃ₙ²+3n−2n−1 (3)

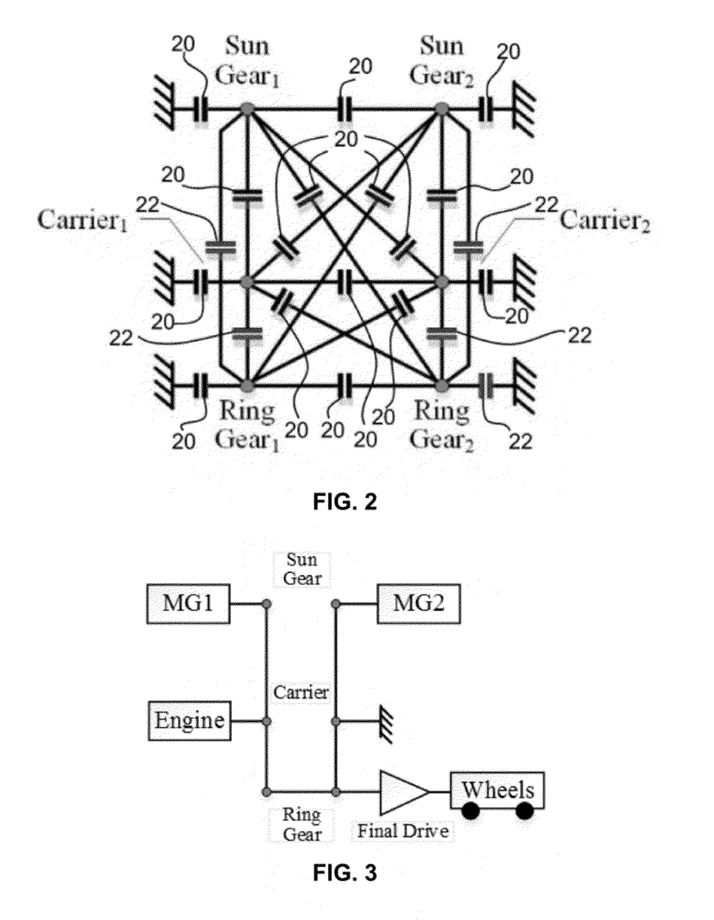

As an example, the diagram of a double PG system is presented in FIG. 2, where there is at total of sixteen (16) clutches 20 implemented with redundant clutches 22 (assuming the vehicle output is on the 2^{nd} ring gear).

To avoid redundant designs and to facilitate systematic automatic modeling procedure, an assumption is made in advance: any one node cannot be connected with all three nodes on the other PG at the same time since it is the same case that it is connected with 2 nodes on the other PG.

### Automated Modeling

In this subsection, the automated modeling process for multiple PGs is described, following which the dynamic model in the form of A\dot{Ω}=T will be derived.

Step 1: Initialize A₀ Matrix

The dynamic of the system without any connection can be represented as Eq. (4), where T₀ is the component torque, \dot{Ω} is the angular acceleration of the powertrain components/PG nodes and \dot{Ω} is the generalized acceleration vector. A₀ is a 4n×4n matrix and it can be decomposed into four parts: J is a diagonal matrix with a dimension of 3n×3n, reflecting the inertia of the system. The first four elements of the principal diagonal of J are replaced by the inertias of the vehicle, engine, MG1 and MG2. Besides the powertrain components, the rest diagonal entries in J will be filled with the planetary gear node which is not assigned with any powertrain components, with the sequence as ring gear, carrier and sun gear, from the first PG to the last PG.

$${A}_{0} {\dot{Ω}}_{0} = [ \begin{matrix}J & D \\ {D}^{T} & 0\end{matrix} ] [ \begin{matrix}\dot{Ω} \\ F\end{matrix} ] = [ \begin{matrix}T \\ 0\end{matrix} ] = {T}_{0} \qquad ( 4 )$$

The connections of planetary gear nodes with the 4 components determine the entries of the upper-right 3n×n constrain matrix D and its symmetric n×3n matrix D^{T} on the bottom-left. Those two matrices are associated with the internal force F_{(.)} between the gear teeth and the number of columns of D is equal to the number of PGs. When one powertrain component is connected to a PG node, the “node coefficient” will be entered in the D matrix: −S_{(.)} if it is connected with the sun gear of the (.)^{th} PG; −R_{(.)} if it is connected with the ring gear of the (.)^{th} PG; R_{(.)}+S_{(.)} if it is connected with the carrier of the (.)^{th} PG.

An example for the configuration used in THS-II (Prius MY2010) is shown in FIG. 3, whose corresponding matrices for Eq. (5) are given in Eq. (5).

$${A}_{0} = [ \begin{matrix}{I}_{out} + {I}_{r 2} & 0 & 0 & 0 & 0 & 0 & 0 & - {R}_{2} \\ 0 & {I}_{e} + {I}_{e 1} & 0 & 0 & 0 & 0 & {R}_{1} + {S}_{1} & 0 \\ 0 & 0 & {I}_{MG 1} + {I}_{s 1} & 0 & 0 & 0 & - {S}_{1} & 0 \\ 0 & 0 & 0 & {I}_{MG 2} + {I}_{s 2} & 0 & 0 & 0 & - {S}_{2} \\ 0 & 0 & 0 & 0 & {I}_{r 1} & 0 & - {R}_{1} & 0 \\ 0 & 0 & 0 & 0 & 0 & {I}_{e 2} & 0 & {R}_{2} + {S}_{2} \\ 0 & {R}_{1} + {S}_{1} & - {S}_{1} & 0 & - {R}_{1} & 0 & 0 & 0 \\ - {R}_{2} & 0 & 0 & - {S}_{2} & 0 & {R}_{2} + {S}_{2} & 0 & 0\end{matrix} ] , \\ {T}_{0} = [ \begin{matrix}{T}_{Load} & {T}_{e} & {T}_{MG 1} & {T}_{MG 2} & 0 & 0 & 0 & {0 ]}^{T} ,\end{matrix} \\ {\dot{Ω}}_{0} = [ \begin{matrix}{\dot{ω}}_{out} & {\dot{ω}}_{eng} & {\dot{ω}}_{MG 1} & {\dot{ω}}_{MG 2} & {\dot{ω}}_{r 1} & {\dot{ω}}_{e 2} & {F}_{1} & {{F}_{2} ]}^{T}\end{matrix} \qquad ( 5 )$$

Step 2: Define Transition Matrix

Transition matrices M and P are defined according to the clutch engagement. M is initialized as a 4n×4n identity matrix with the same dimension as A₀. When the i^{th} node is connected with the j^{th} node, without losing generality, assuming i<j, the processes shown in Eqs. (6) and (7) are executed for the M matrix. If the clutch is engaged to ground the i^{th} node, i^{th} row=[], where [] means that the row is eliminated. After this step, M becomes an (4n−q)×4n matrix where q is the number of clutches engaged.

i^{th} row=i^{th} row+j^{th} row (6)

j^{th} row=[] (7)

The generation of P is similar to that of M but only row elimination is followed: P is initiated as a 4n×4n identity matrix. When the i^{th} node is connected with the j^{th} node, without losing generality, assuming i<j, Eq. (7) is applied. If the clutch is engaged to ground the i^{th} node, i^{th} row=[]. After this step, P becomes an (4n−q)×4n matrix.

Note that since three power components (engine, MG1 and MG2) are implemented in the powertrain system, the system degree of freedom must be within the range of one to three so that the vehicle is controllable and drivable. For each non-redundant clutch engagement, one degree of freedom will be reduced. Therefore the total number of clutches q to be engaged is within the range of [2n−3, 2n−1].

Step 3: Formulate the Dynamic of the System

The dynamic matrix A of the powertrain system with clutch engagement is generated through Eq. (8). The system dynamics of a certain mode can be represent in Eq. (9). As an example, Eq. (10) and (11) shows the equations of the THS-II powertrain system depicted in FIG. 3.

$$\begin{matrix} A = M {A}_{0} {M}^{T} , T = M {T}_{0} , \dot{Ω} = P {\dot{Ω}}_{0} & ( 8 ) \\ A \dot{Ω} = T & ( 9 ) \\ M = [ \begin{matrix}1 & 0 & 0 & 0 & 1 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 0 & 0 & 1 & 0 \\ 0 & 0 & 0 & 0 & 0 & 0 & 0 & 1\end{matrix} ] , P = [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 0 & 0 & 1 & 0 \\ 0 & 0 & 0 & 0 & 0 & 0 & 0 & 1\end{matrix} ] & ( 10 ) \\ A = [ \begin{matrix}{I}_{out} + {I}_{r 2} + {I}_{r 1} & 0 & 0 & 0 & - {R}_{1} & - {R}_{2} \\ 0 & {I}_{e} + {I}_{e 1} & 0 & 0 & {R}_{1} + {R}_{2} & 0 \\ 0 & 0 & {I}_{MG 1} + {I}_{s 1} & 0 & - {S}_{1} & 0 \\ 0 & 0 & 0 & {I}_{MG 2} + {I}_{s 2} & 0 & - {S}_{2} \\ - {R}_{1} & {R}_{1} + {R}_{2} & - {S}_{1} & 0 & 0 & 0 \\ - {R}_{2} & 0 & 0 & - {S}_{2} & 0 & 0\end{matrix} ] & ( 11 ) \\ T = [ \begin{matrix}{T}_{Load} \\ {T}_{e} \\ {T}_{MG 1} \\ {T}_{MG 2} \\ 0 \\ 0\end{matrix} ] , \dot{Ω} = [ \begin{matrix}{\dot{ω}}_{out} \\ {\dot{ω}}_{e} \\ {\dot{ω}}_{MG 1} \\ {\dot{ω}}_{MG 2} \\ {F}_{1} \\ {F}_{2}\end{matrix} ] & \end{matrix}$$

### Mode Screening

With multiple clutch operation, various modes can be achieved. For the mode in which the vehicle cannot be powered by any powertrain component, it is defined as an infeasible mode. For some modes which have identical driving effect (i.e., with the same control input(s), the acceleration response on each powertrain component are the same), one is kept and the rest are deemed as redundant. Distinguishing redundant mode is important for simulation efficiency in the optimization process later on. In this section, the process and steps to identify and eliminate infeasible and redundant modes are described.

Step 1: Construct A* Matrix

The A matrix is inverted to obtain the dynamic equation to relate input to state derivative. For a controllable powertrain system (i.e., the speed of each PG node can be controlled), the A matrix is always invertible. At the same time, not every element of the A⁻¹ matrix is useful. The useful part of A⁻¹ is extracted as following, to obtain a final 4×4 matrix A*, as shown in Eq. (12).

$$[ \begin{matrix}{\dot{ω}}_{out} \\ {\dot{ω}}_{eng} \\ {\dot{ω}}_{mg 1} \\ {\dot{ω}}_{m g 2}\end{matrix} ] = {A}^{⋆} [ \begin{matrix}{T}_{load} \\ {T}_{eng} \\ {T}_{mg 1} \\ {T}_{mg 2}\end{matrix} ] \qquad ( 12 )$$

In order to construct A* matrix, the last n columns and rows as well as the columns and rows associated with any free node (node with no powertrain component attached) in A⁻¹ will be eliminated since they have no impact to the final state equation. There are two cases after the elimination:

$${A}^{- 1} = [ \begin{matrix}{A}_{11}^{inv} & {A}_{12}^{inv} & {A}_{13}^{inv} & {A}_{14}^{inv} & {A}_{15}^{inv} & {A}_{16}^{inv} \\ {A}_{21}^{inv} & {A}_{22}^{inv} & {A}_{23}^{inv} & {A}_{24}^{inv} & {A}_{25}^{inv} & {A}_{26}^{inv} \\ {A}_{31}^{inv} & {A}_{32}^{inv} & {A}_{33}^{inv} & {A}_{34}^{inv} & {A}_{35}^{inv} & {A}_{36}^{inv} \\ {A}_{41}^{inv} & {A}_{42}^{inv} & {A}_{43}^{inv} & {A}_{44}^{inv} & {A}_{45}^{inv} & {A}_{46}^{inv} \\ {A}_{51}^{inv} & {A}_{52}^{inv} & {A}_{53}^{inv} & {A}_{54}^{inv} & {A}_{55}^{inv} & {A}_{56}^{inv} \\ {A}_{61}^{inv} & {A}_{62}^{inv} & {A}_{63}^{inv} & {A}_{64}^{inv} & {A}_{65}^{inv} & {A}_{66}^{inv}\end{matrix} ] \\ {A}^{⋆} = [ \begin{matrix}{A}_{11}^{inv} & {A}_{12}^{inv} & {A}_{13}^{inv} & {A}_{14}^{inv} \\ {A}_{21}^{inv} & {A}_{22}^{inv} & {A}_{23}^{inv} & {A}_{24}^{inv} \\ {A}_{31}^{inv} & {A}_{32}^{inv} & {A}_{33}^{inv} & {A}_{34}^{inv} \\ {A}_{41}^{inv} & {A}_{42}^{inv} & {A}_{43}^{inv} & {A}_{44}^{inv}\end{matrix} ] \qquad ( 13 )$$

(1) If there is no collocation of powertrain components due to clutch engagement, the A* matrix is acquired after the elimination described in the previous paragraph. As the THS-II example described in FIG. 3, its A⁻¹ and A* are shown in Eq. (13).

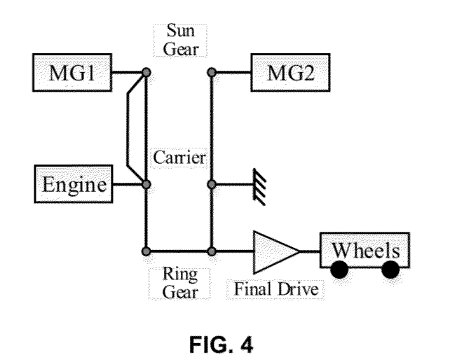

(2) If there is collocation, the torque coefficients corresponding to the collocated components are duplicated, making the sequence of the coefficients correspond to “output”, “engine”, “MG1” and “MG2”. In addition, since the acceleration of the collocated components are the same, it will lead to identical rows in the A* matrix. An example of a parallel mode and its A⁻¹ and A* are shown in FIG. 4 and Eq. (14).

$${A}^{- 1} = [ \begin{matrix}{A}_{11}^{inv} & {A}_{12}^{inv} & {A}_{13}^{inv} & {A}_{14}^{inv} & {A}_{15}^{inv} \\ {A}_{21}^{inv} & {A}_{22}^{inv} & {A}_{23}^{inv} & {A}_{24}^{inv} & {A}_{25}^{inv} \\ {A}_{31}^{inv} & {A}_{32}^{inv} & {A}_{33}^{inv} & {A}_{34}^{inv} & {A}_{35}^{inv} \\ {A}_{41}^{inv} & {A}_{42}^{inv} & {A}_{43}^{inv} & {A}_{44}^{inv} & {A}_{45}^{inv} \\ {A}_{51}^{inv} & {A}_{52}^{inv} & {A}_{53}^{inv} & {A}_{54}^{inv} & {A}_{55}^{inv}\end{matrix} ] \\ {A}^{⋆} = [ \begin{matrix}{A}_{11}^{inv} & {A}_{12}^{inv} & {A}_{12}^{inv} & {A}_{13}^{inv} \\ {A}_{21}^{inv} & {A}_{22}^{inv} & {A}_{22}^{inv} & {A}_{23}^{inv} \\ {A}_{21}^{inv} & {A}_{22}^{inv} & {A}_{22}^{inv} & {A}_{23}^{inv} \\ {A}_{31}^{inv} & {A}_{32}^{inv} & {A}_{32}^{inv} & {A}_{33}^{inv}\end{matrix} ] \qquad ( 14 )$$

Step 2: Refine A* Matrix

For each row of A*, if three of the four elements are zero, that means this component have no connection with the other three components, i.e., the rest of the powertrain, then all the elements in the row are set to zero.

If both the 1st and the 2nd element of the 3rd and 4th row of A* are 0, it means the MGs are neither connected with the engine nor the vehicle, they will not affect the function of the mode, and 3rd and 4th row will be set to 0.

Step 3: Define Entries in A* Matrix

The four rows of the A* matrix will be named as Vᵥₑₕ, V_{eng}, V_{MG1} and V_{MG2} respectively and the elements of the Vᵥₑₕ row vector are named Cᵥₑₕ, C_{eng}, C_{MG1}, C_{MG2} for later reference.

If the first row of A* is zero, the vehicle output is not affected by any powertrain component, making it infeasible (useless). In addition, vehicle modes with identical A* matrices are deemed identical and only one mode will be kept.

### Mode Classification

All feasible modes are classified according to the category shown in Table 1. Since the DoF varies from 1 to 3, and the mode can be one of the EV, hybrid or engine only case, logically, the 14 classes of mode in Table 1 are all possible modes when one engine, one output shaft and two MGs are assigned, regardless of the number of PGs or Ravigneaux PGs.

Step 1: Determine the System DoF

Since each row in A* matrix represents the relationship between the torque input and a component's acceleration, rank reduction means that the acceleration of some component can be represented as a linear combination of the accelerations of other components. The DoF of the mode is the same as rank(A*) which cannot be more than 3.

Step 2: Formulate Auxiliary Matrixes

6 more matrixes are generated for further rank analysis: M_{VE}=[Vᵥₑₕ; V_{eng}], M_{VMG1}=[Vᵥₑₕ; V_{MG1}], M_{VMG2}=[Vᵥₑₕ; V_{MG2}], M_{EMG1}=[V_{eng}; V_{MG1}], M_{EMG2}=[V_{eng}; V_{MG2}], M_{MG1}; V_{MG2}=[V_{MG1}; V_{MG2}] and the ranks of those matrixes are denoted as r_{VE}, r_{VMG1}, r_{VMG2}, r_{EMG1}, r_{EMG2}, r_{MG1MG2}.

TABLE 1
MODE TYPES AND CRITERIA

| | Mode Classification | Criteria |
|---|---|---|
| 1 | Series Mode | DoF = 2, C_{eng} = 0, V_{eng}(2) ≠ 0 |
| | | C_{MG1}C_{MG2} = 0, |
| 2 | Compound Split (3 DoF) | DoF = 3 |
| 3 | Compound Split (2 DoF) | DoF = 2, C_{eng} ≠ 0, |
| | | C_{MG1}C_{MG2} ≠ 0, r_{VMG1} = 2, r_{VE} = 2, |
| | | r_{VMG2} = 2, r_{EMG1} = 2, r_{EMG2} = 2 |
| 4 | Input Split | DoF = 2, C_{eng} ≠ 0, |
| | | r_{VMG1} r_{VMG2} = 2, C_{MG1}C_{MG2} ≠ 0 |
| 5 | Output Split | DoF = 2, C_{eng} ≠ 0, |
| | | r_{EMG1} r_{EMG2} = 2, C_{MG1}C_{MG2} ≠ 0 |
| 6 | Parallel with EVT | DoF = 2, C_{eng} ≠ 0, |
| | (Engine + 1MG) | C_{MG1} C_{MG2} = 0, C_{MG1}² + C_{MG2}² ≠ 0 |
| 7 | Parallel with EVT | DoF = 2, C_{eng} ≠ 0, |
| | (Engine + 2 MGs in serial) | C_{MG1}C_{MG2} ≠ 0, r_{MG1MG2} = 1 |
| 8 | Engine Only | DoF = 1, C_{eng} ≠ 0 |
| | (Fixed Gear) | C_{MG1}² + C_{MG2}² = 0 |
| 9 | Parallel with Fixed Gear | DoF = 2, C_{eng} ≠ 0 |
| | (Engine + 2MGs, 2 DoF) | r_{VE} = 1, C_{MG1}C_{MG2} ≠ 0 |
| 10 | Parallel with Fixed Gear | DoF = 1, C_{eng} ≠ 0 |
| | (Engine + 2MGs, 1DoF) | C_{MG1}C_{MG2} ≠ 0 |
| 11 | Parallel with Fixed Gear | DoF = 1, C_{eng} ≠ 0 |
| | (Engine + 1MG, 1DoF) | C_{MG1} C_{MG2} ≠ 0, C_{MG1}² + C_{MG2}² ≠ 0 |
| 12 | EV (2MGs, 2 DoF) | DoF = 2, C_{eng} = 0, V_{eng}(2) = 0 |
| 13 | EV (2MGs, 1 DoF) | DoF = 1, C_{eng} = 0 |
| | | C_{MG1}C_{MG2} ≠ 0 |
| 14 | EV (1MG, 1 DoF) | DoF = 1, C_{eng} = 0 |
| | | C_{MG1} C_{MG2} = 0, C_{MG1}² + C_{MG2}² ≠ 0 |

### Power-Weighted Efficiency Analysis for Rapid Sizing

The Power-weighted Efficiency Analysis for Rapid Sizing (PEARS) method was developed as a near-optimal energy management strategy for fast sizing and design, and it was found to be over 10,000 times faster than DP. The methodology can be applied to more general circumstances, including multiple PG hybrid powertrains, after some minor enhancements.

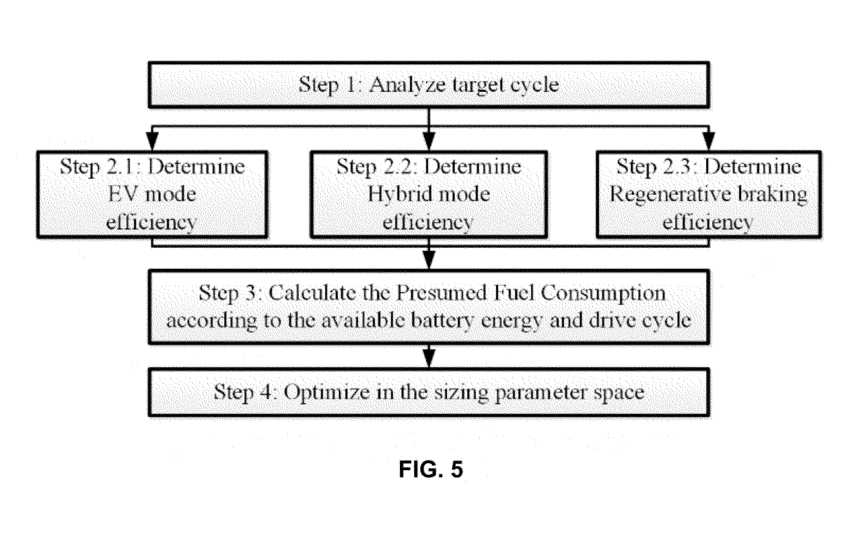

The modified procedure of PEARS is presented in FIG. 5 and described as follows.

Step 1: Analyze Target Cycle

The target drive cycle is discretized into a 2D table with the X and Y axes being the vehicle speed and acceleration, respectively. The table entries represent the probability density of the cells. The cells in the table are referred as Speed and Acceleration Cell (SAC) in the subsequent discussion.

Step 2: Determine Efficiency for each Mode

In step 2, the Power-weighted Efficiency (PE) for every mode in each SAC is examined. The 14 types of modes are separated into two categories depending on whether the engine is operational or not: EV modes and Hybrid modes (where the engine-only operation is treated as a special case of Hybrid modes).

Step 2.1: Determine EV Mode Efficiency

The efficiency of the EV modes is described by Eq. (15), where P_{EV}^{loss} includes both battery loss and electric-mechanical loss; P_{EV}ⁱⁿ refers to the power flowing into the system. In the driving scenario, P_{EV}ⁱⁿ is the battery power. In the braking case, it is the regenerative braking power. For modes with one DoF, all possible torque combinations will be compared and the best efficiency is recorded. For modes with two DoFs, the accelerations of all powertrain components are assumed to be the same (an approximation analyzed and justified in). The best possible efficiency for each mode is calculated from Eq. (16). The mode with the highest efficiency is then selected as the optimal EV mode for each SAC.

$$\begin{matrix}{η}_{EM} = 1 - \frac{{P}_{EM}^{loss}}{{P}_{EM}^{in}} & ( 15 ) \\ {η}_{EV}^{⋆} {{\vert}_{{ω}_{out} , {\dot{ω}}_{out}} = max [ {η}_{EV} ( {T}_{MG 1} , {T}_{MG 2} ) ] \vert}_{{ω}_{out} , {\dot{ω}}_{out}} & ( 16 )\end{matrix}$$

Step 2.2: Determine Hybrid Mode Efficiency

For hybrid modes, the Power-weighted efficiency (PE) will be evaluated. There are two possible power sources for hybrid modes: the engine and the battery. In general, the power used by the system can be divided into four parts as shown in Table 2, where Pₑ_{_{—}}₁+Pₑ_{_{—}}₂+Pₑ_{_{—}}₃ is the total engine output power. P_{batt}⁺ is the battery power consumed and it is 0 when the battery power is less than 0. The power-weighted efficiency is calculated in Eq. (17), where P_{fuel} stands for the rate of fuel energy injected; footnotes G and M stand for generator (when the power is negative) and motor (when the power is positive or zero); ηₑ_{_{—}}ₘₐₓ, η_{G}_{_{—}}ₘₐₓ and η_{M}_{_{—}}ₘₐₓ are the highest efficiency of the engine, generator and the motor for all operating conditions. Due to the fact that the engine efficiency is much lower than the efficiency of the electrical system, normalization has to be used in component power efficiency calculation, otherwise the engine operation will not be selected.

Similar to the EV cases, all torque and speed combinations will be examined. The mode with the highest efficiency will be selected for each SAC.

$$\begin{matrix}{η}_{Hybrid} ( {ω}_{e} , {T}_{e} ) = \frac{{P}_{e \_ 1} {η}_{G} {η}_{batt} \text{/} ( {η}_{e \_ max} {η}_{G \_ max} )}{{P}_{fuel} + {\underline{P}}_{batt}} + \frac{{P}_{e \_ 2} {η}_{G} {η}_{M} \text{/} ( {η}_{e \_ max} {η}_{G \_ max} {η}_{M \_ max} )}{{P}_{fuel} + {\underline{P}}_{batt}} + \frac{{P}_{e \_ 3} \text{/} {η}_{e \_ max} + {\underline{P}}_{batt} {η}_{batt} {η}_{M} \text{/} {η}_{M \_ max} )}{{P}_{fuel} + {\underline{P}}_{batt}^{+}} & ( 17 ) \\ {η}_{Hybrid}^{⋆} {{\vert}_{{ω}_{out} , {\dot{ω}}_{out}} = max [ {η}_{Hybrid} ( {ω}_{e}^{⋆} , {T}_{e}^{⋆} ) ] \vert}_{{ω}_{out} , {\dot{ω}}_{out}} & ( 18 )\end{matrix}$$

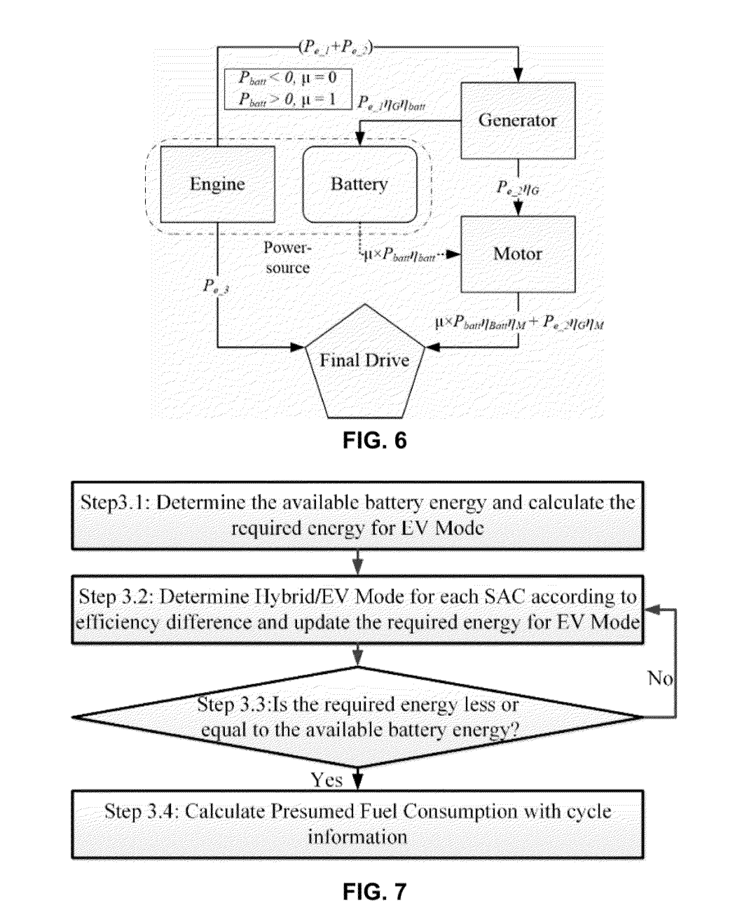

FIG. 6 describes the power flow paths where μ is a flag to indicate whether the battery assist is on or not.

TABLE 2
POWER-FLOW OF THE HYBRID SYSTEM

| Power Flow | Description |
|---|---|
| Pₑ_{_{—}}₁ | Engine power flows through the generator to the |
| | battery |
| Pₑ_{_{—}}₂ | Engine power flows through generator to the motor |
| Pₑ_{_{—}}₃ | Engine power directly flows to the final drive |
| P_{batt}⁺ | Battery power when it is positive; 0 when the |
| | battery power is negative |

Step 2.3: Determine Regenerative Braking Efficiency

When the vehicle decelerates, regenerative braking is engaged and the EV mode with the highest efficiency is chosen for its operation. The calculation of efficiency follows Eq. (15) and Eq. (16), with P_{EV}ⁱⁿ defined as the mechanical power flowing into the system.

Step 3: Calculate the Optimal Mode Shift with DP

Once the optimal control executions are determined for each mode at each vehicle STC, the next step is to determine the mode to be used during the drive cycle.

The states and controls of the DP problem are shown in Table 1. The first state is battery energy consumption, which is calculated from Step 2; the second state and control are both the operating mode. Note that the mode is a state because the cost function includes the mode shift penalty.

TABLE 1
THE STATES AND CONTROLS FOR PEARSDP PROBLEM

| States and Controls | Description |
|---|---|
| State 1 | Battery energy consumption |
| | (Equivalent to SOC) |
| State 2 | Previous Mode |
| Control 1 | Mode selection |

The cost function and constraint of the DP problem are described in Eqs. (19) and (20): the optimization objective is to minimize fuel consumption while keeping the mode shift and final SOC small.

$$\begin{matrix}J = min [ {\sum }_{t = 1}^{N} ( {L}_{t} + {γ}_{1} {Δω}_{e}^{2} + {γ}_{2} {Δω}_{MG 1}^{2} + {γ}_{3} {Δω}_{MG 2}^{2} ) + {α ( {SOC}_{desired} - {SOC}_{N} )}^{2} ] & ( 19 ) \\ Subject to & \\ {SOC}_{min} \leq SOC \leq {SOC}_{m a x} & ( 20 )\end{matrix}$$

where γ₁, γ₂, γ₃ are the factors to penalize for speed difference, and α is the factor for the equality constraint of the final SOC.

This low-dimension DP problem only takes 15 to 30 seconds (depending on the number of modes for the design being studied) to solve for the 1372-second long Federal Urban Driving Schedule (FUDS).

### Case Study

In this section, we will choose the double PG system as a case study, combining the modeling procedure introduced in Section 2 and PEARS described in Section 3 to find the best design.

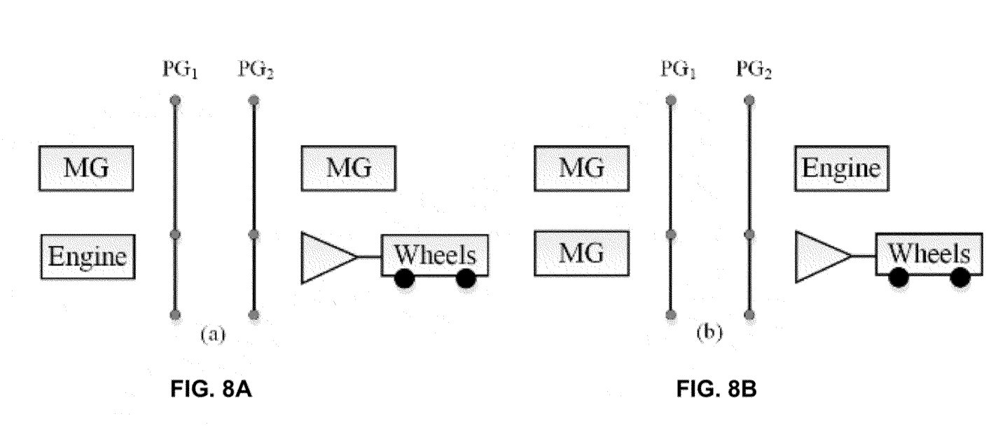

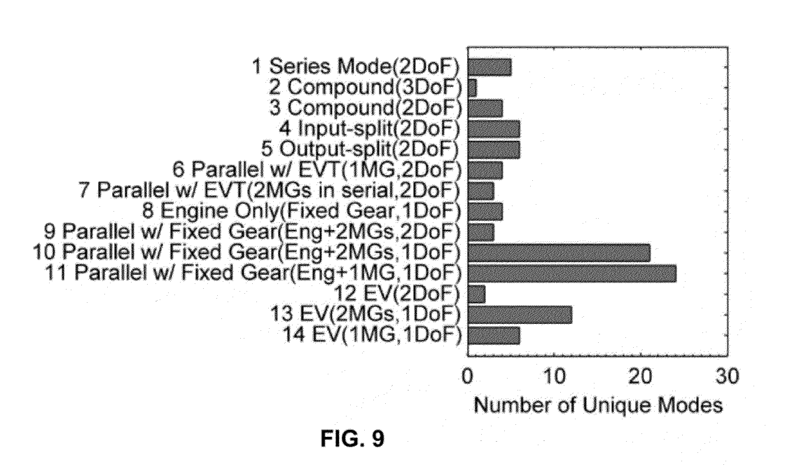

For a double PG system, there are totally 360 different configurations that can be achieved according to Eq. (3). However, in this study, we only considered the case that each planetary gear has two powertrain components, since having three powertrain components on the same PG will lead to very limited design flexibility. Therefore, the number of configurations is down to C₂¹C₂¹P₃²P₃²=216. In addition, topologically, the remaining 216 configurations can be classified into two categories, depending on whether the engine and vehicles are on the same side or not, as described in FIG. 8. For category (a), there are C₂¹C₂¹P₃²P₃²=144 configurations; while for category (b), there are C₂¹P₃²P₃²=72 configurations left. Since varying the connection of a node on one planetary gear will only change the relative speed ratio but not the function of the mode, for each configuration with in the same category, they have the same number and classification of mode. THS-II (Toyota Hybrid Synergy Drive) which is used in the current generation of Prius, Camry hybrid and Highlander hybrid is an example of category (a) shown in FIG. 9.

Due to the large design pool, in the present disclosure, we will only pick THS-II and use the parameters of Prius 2010 in Table 4 to proceed an in-depth study.

While we start by studying the design cases with all 16 clutches, it is clear that the corresponding results would only serve as a benchmark and cannot be easily implemented in practice. In addition, it is hard to believe we really need all the modes enabled by 16 clutches. In this study, we will further investigate the case when three clutches are used for the following reasons: First, since a double PG system initially has 4 DoF without any connections and a non-redundant clutch engagement will reduce system DoF by one, at most 3 clutches need to be engaged simultaneously. Moreover, it may lead to as many as 7 different modes, resulting in many feasible and sub-optimal designs. Second, Chevy Volt uses 3 clutches, so we assume it is feasible in practice.

TABLE 4
PARAMETERS OF THE VEHICLE USED IN THE
CASE STUDY (BASED ON PRIUS 2010)

| Component | Parameters |
|---|---|
| Engine | 98 hp@5200 rpm |
| | 105 lbft@4000 rpm |
| P_{MG1max}(kW) | 42 |
| P_{MG2max}(kW) | 60 |
| FR | 3.2 |
| R₁:S₁ | 2.6 |
| R₂:S₂ | 2.63 |
| Vehicle mass(kg) | 1450 |

According to Eq. (3), 16 clutches for double PG system will give us all possible 2¹⁶=65536 modes in theory. After modeling with practical assumptions and the applying the screening algorithm, for configurations described in FIG. 8(a), only 101 feasible and non-redundant modes remain, with the two MGs treated as different components. FIG. 9 shows the distribution of the feasible and non-redundant modes in FIG. 8(a) for the configuration used in THS-II.

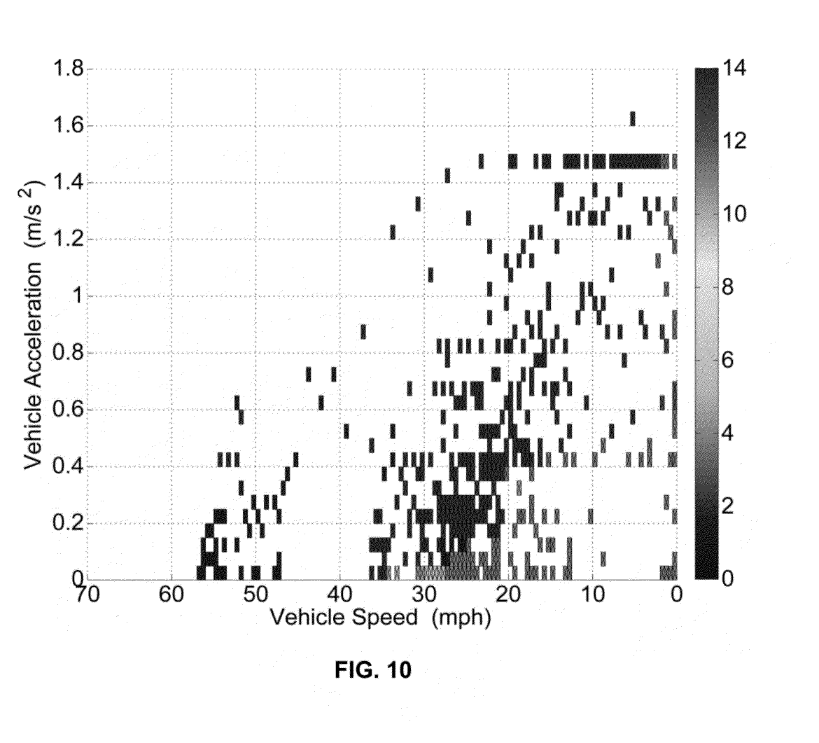

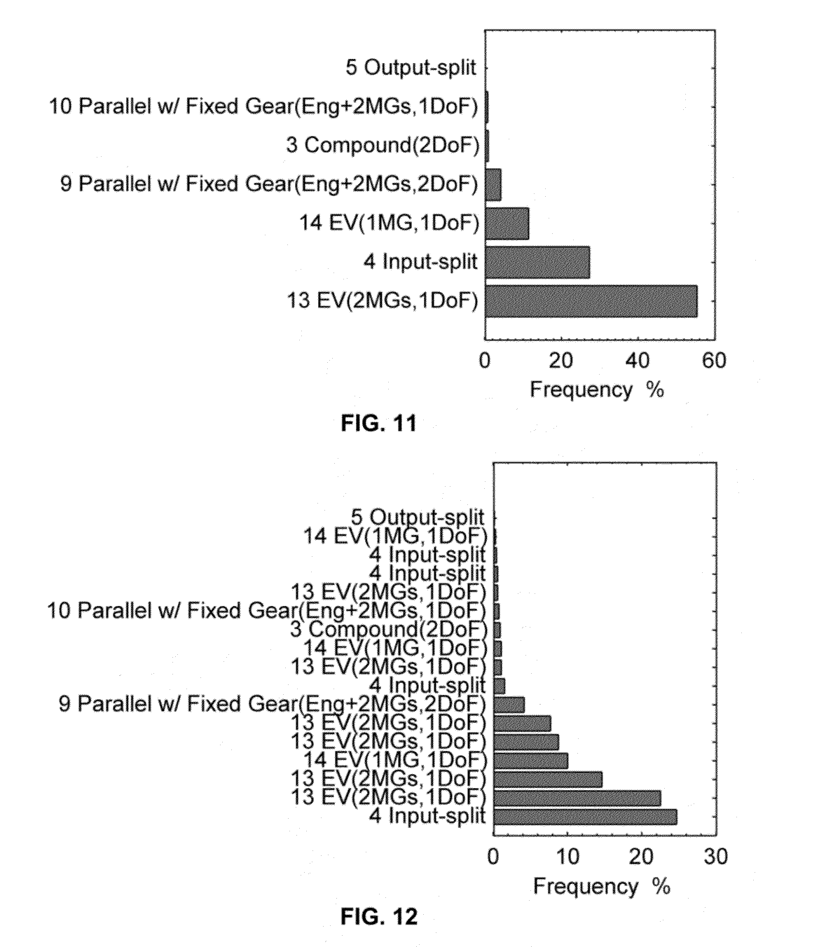

The proposed PEARS process is applied to analyze the THS-II powertrain connection, but the locations of clutches and their engagement are to be selected. The component sizes are all identical to Prius 2010, as shown in Table 3. With the color code shows the mode ID (1-14) defined in FIG. 10, the optimal mode distribution for HEV driving in the FUDS cycle is shown in FIG. 10 and FIG. 11.

From FIG. 11, we can see that only 7 out of the 14 types of modes are used. If we further analyze the details of the modes used (rather than simply looking at the type of modes), as can be seen from FIG. 12, 17 different modes are used, and the ones most frequently used are input split, EV and parallel modes.

To enable all the 17 modes shown in FIG. 12, 11 out of the 16 clutches are needed. Even when only the 7 most frequently used modes are considered, which account for 92% of the total driving time, 10 different clutches are necessary which is apparently unrealistic due to reasons associated with cost and system complexity.

For practical considerations, as suggested at the beginning of this section, only 3 clutches are allowed. It leads to C₁₆³=560 different combinations; and for each combination, it may affect up to 7 (out of 101) different modes. PEARS are applied to all 560 combinations, which altogether takes about 15 minutes to solve. After extracting the control rules from the PEARS algorithm, simulation will be applied and the fuel consumption can be calculated for the designs with most promising PFCs.

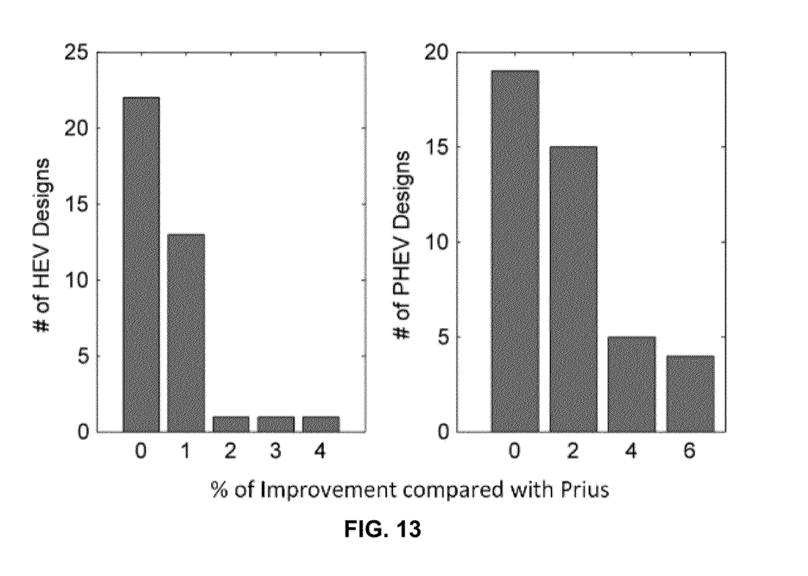

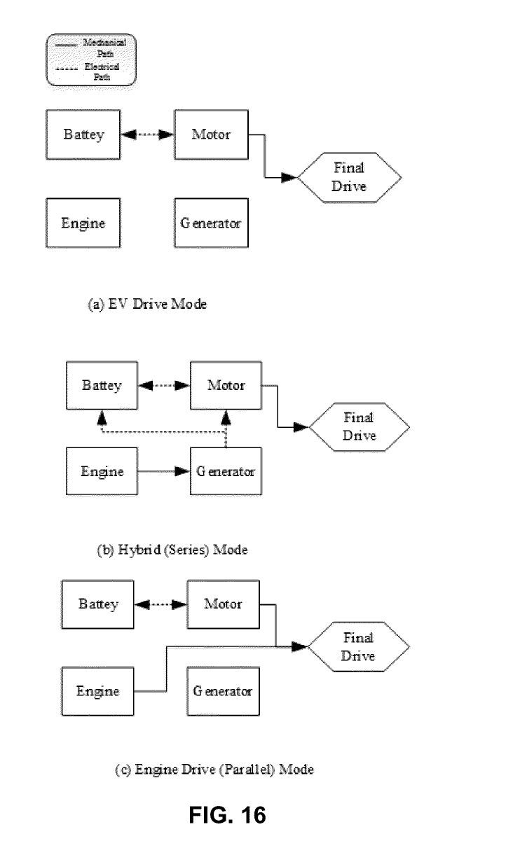

In the present disclosure, we use a combined city and highway cycle to evaluate the performance of the resulting design, with 55% weight on the city cycle (FUDS) and 45% on the highway (HWFET). At the same time, drivability is also considered which requires the design candidate to be able to accelerate from 0 to 60 mph within 10 seconds. By using drivability screening and the PEARS based approach, about 20 PHEV and HEV designs with 3 clutches are found to achieve better fuel economy than Prius by choosing clutch locations appropriately, as shown in FIG. 13. Note that “a design” here and in FIG. 16 refers to one particular combination of clutch allocation for a given configuration.

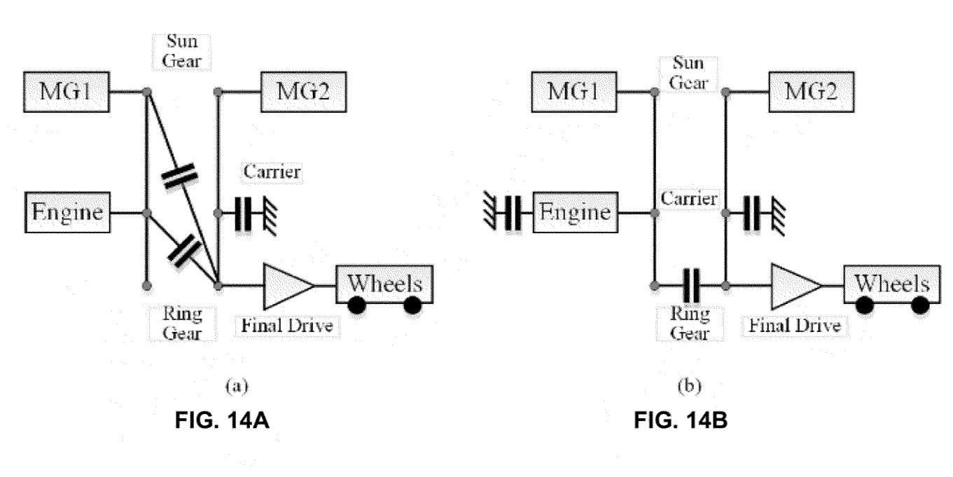

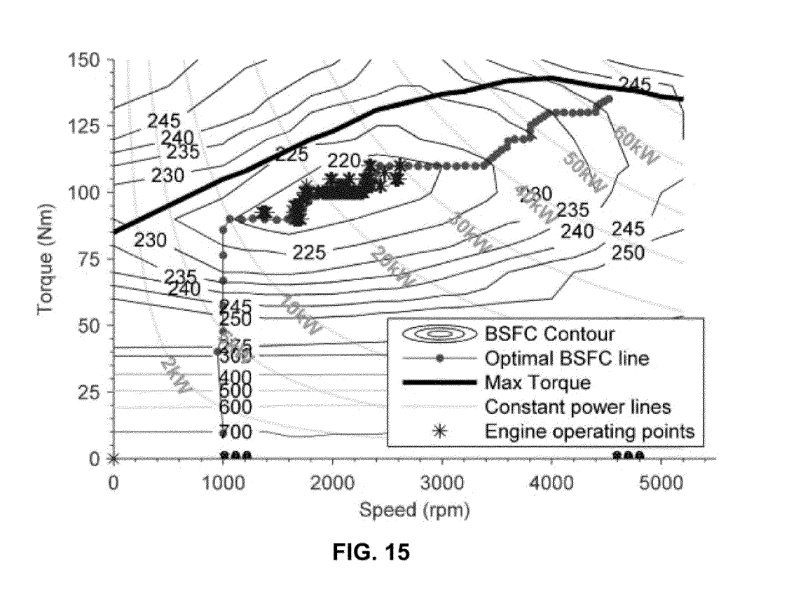

The top two best PHEV designs are shown in FIG. 14. It is observed that design (a) only has two fixed gear parallel modes to operate as a hybrid mode while the engine speed is always the same as the speed of output shaft if it is on. Besides the hybrid modes, it uses either one or both of its MGs to operate in the EV mode. The reason why this design can achieve great fuel economy is that the engine is only on when high efficiency can be achieved, as its operating points in HWFET shown in FIG. 15.

It should be noted that the design similar to FIG. 14(a) has been used on Honda Accord Hybrid 2014, shown in FIG. 16, which has a very similar single fixed gear hybrid mode (Engine Drive) and EV mode (EV Drive). The only main difference is that for design (a) in FIG. 14, it is not equipped with a Series mode (Hybrid Mode in FIG. 16). The reason is that the cycle information is already known when we do the optimization process, the engine on timing is well-determined and battery energy can be carefully managed, therefore no back-up Series mode is necessary for the case when the vehicle is running at a low speed with low battery SOC.

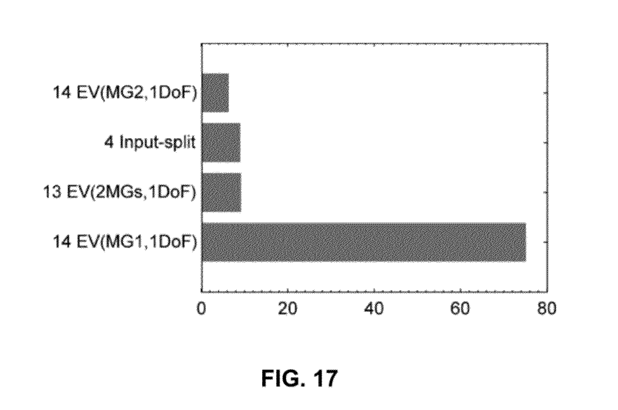

The second best PHEV design is shown in FIG. 14(b). This design is quite similar to the THS-II design illustrated in FIG. 3. As can be observed in FIG. 17, compared with the THS-II design, besides having an input-split mode, three EV modes are used. The MG1-only mode (which is the generator of Prius) is used particularly frequently.

In addition to their excellent fuel economy, the drivability of the two best PHEV designs is remarkable as shown in Table 5. For the design depicted in FIG. 14(a), with the help of Mode 10 (in Table 1, Parallel mode with Fixed Gear, Engine+2MGs, 1DoF), the torque output comes from both MGs during launching. When the speed of output shaft is beyond the engine idling speed, engine torque kicks in to assist accelerating the vehicle. For the example (b), its Mode 13 (in Table 1, EV, 2MGs, 1DoF) can provide even higher average power than the example (a) during the 0 to 60 mph without the engine since it employs a more favorable gear ratio between MG1 to the output shaft.

TABLE 5
COMPARISON BETWEEN PRIUS 2010 AND TWO PHEV
DESIGNS IN COMBINED FUDS AND HWFET CYCLES

| Designs | Design (a) | Design (b) | Prius 2010 |
|---|---|---|---|
| 0 to 60 mph (s) | 7.7 | 7.4 | 8.6 |
| Normalized fuel | 92.2% | 93.3% | 100% |
| consumption | | | |

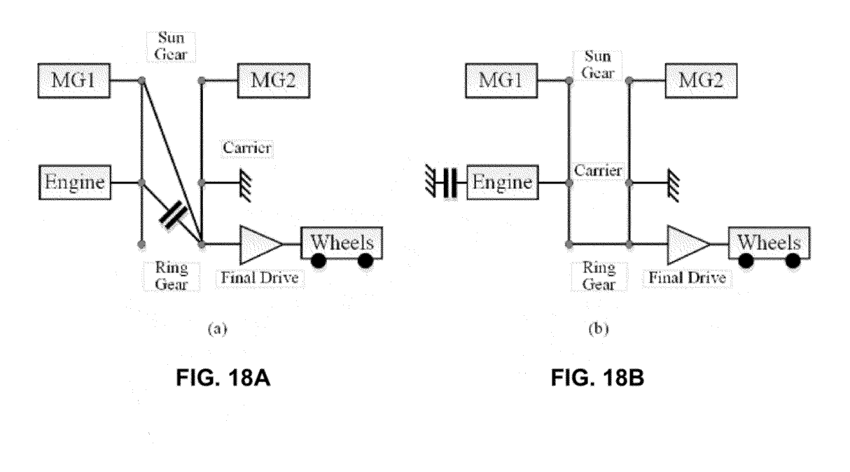

Further analysis reveals that, for both design (a) and (b) of FIG. 14, not all of their modes have been used and some clutches can be replaced with permanent connections. This observation leads to two simplified designs using only one clutch, as shown in FIG. 18, which have the same fuel economy and drivability performance as the original three clutch designs. Although the final designs have only one clutch, it is the proposed design methodology that finds the best permanent connection and clutch locations.

Nevertheless, it should be pointed out that in this research, component sizing has not been pursued. We use this case study to demonstrate the power of this systematic design methodology. The winning designs may vary according to powertrain configurations and component sizes.

### CONCLUSION

According to the present teachings, a systematic automated modeling procedure is presented, which can be used to explore all possible power split configurations deploying any planetary gears with all possible clutch locations. We developed mode screening and identification algorithms to identify and eliminate infeasible and redundant modes. By using PEARS, a near-optimal energy management strategy, the design of double PG multi-mode hybrid vehicles is performed through exhaustive search, resulting in a large number of new and feasible designs. Many of them are shown through simulations to achieve better fuel economy than the benchmark THS-II configuration (used in MY 2010 Prius) when the same engine and electric machines are used. The improvement is especially noticeable for charge depletion operations. Two of the top designs are analyzed, which achieve 7 to 8% better fuel economy than the original Prius PHEV design. Meanwhile, the launching performance of these two designs is significantly better due to their multi-mode operations. Nevertheless, we should point out that the two examples are just a demonstration of the methodology, the optimal result may vary for different configurations and when component sizing is considered.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of designing a planetary gear power-split hybrid powertrain having EV modes and hybrid modes, said method comprising:
a first step of analyzing a target cycle or a number of target cycles having a plurality of speed and acceleration cells and storing in a first memory location;
a second step of determining EV mode efficiency, hybrid mode efficiency, and regenerative braking efficiency based on said first plurality of speed and acceleration cells and storing in a second memory location;
a third step of calculating presumed fuel consumption by calculating required energy for said EV mode, determining hybrid/EV mode, and comparing required battery energy using a processor to determine a first design candidate; and
repeating said steps for the target cycle or cycles to determine a second design candidate and determining with said processor which of said first design candidate and said second design candidate comprises the lowest preferred fuel consumption.

2. The method according to claim 1 wherein said determining said EV mode efficiency is determined in response to battery loss, electric-mechanical loss and power input of said target cycle.

3. The method according to claim 1 wherein said determining said hybrid mode efficiency is determined in response to a power-weighted efficiency.

4. The method according to claim 1 wherein said repeating said steps for a second target cycle comprises modifying a parameter of said second target cycle prior to said repeating said steps.

5. The method according to claim 1 wherein said repeating said steps for a second target cycle comprises repeating said steps for a plurality of target cycles each having a varying parameter relative to the others.
